(19) United States
(12) Patent Application Publication
(10) Pub. No.: US 2014/0103085 A1
(43) Pub. Date: Apr. 17, 2014

(54) Storage Apparatus

(71) Applicant: Eric Michael Patronik, Holualoa, HI (US)

(72) Inventor: Eric Michael Patronik, Holualoa, HI (US)

(21) Appl. No.: 13/654,315

(22) Filed: Oct. 17, 2012

(51) Int. Cl. B60R 9/04

(52) U.S. Cl. 224/318

(57) ABSTRACT

A storage apparatus for storing objects inside or on a vehicle when the roof is either secured or remove which positions between support members, such as a roll bar. Objects are secured between two mesh barriers that are flexible and adjustable. At least one tube forms a rectangular frame for the apparatus. The tubes join with ninety degree fittings to form a substantially rectangular shape. A shelf netting stretches across the tubes to form a flexible platform for supporting the objects. Attachment straps secure the tubes to the support member. A retention barrier wraps around the tubes to provide protection. A retention net overlays the shelf netting to sandwich the objects in between. The retention net includes a nylon border that also secures to the support member with hook and loop straps and clips. A handle provides a gripping surface for supporting a user.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to vehicle accessories. More particularly, one or more embodiments of the invention relate to an overhead storage shelving system for a vehicle.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. One may expect that with an increase in the number of personal items with which people travel, there is becoming less space to store these items, particularly within vehicles. Furthermore, it is believed that these personal items may become a hazard for vehicle occupants. For example, without limitation, these items may move around the vehicle and become lodged in dangerous places such as, but not limited to, under the control pedals of the vehicle or around the steering wheel, making it difficult to control the vehicle. Moreover, unsecured items may fall from the vehicle and become lost or broken when doors are open or when the top is removed or retracted, when applicable.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. Many currently known vehicle storage systems are usually small and configured to be located between the driver and passenger, thus limiting storage space. By way of educational background, another aspect of the prior art generally useful to be aware of is that some currently known vehicle storage systems are configured as overhead systems. It is believed that most current overhead storage systems are bulky, heavy in weight and are often permanently secured to the vehicle. Also, these storage systems may not remain in place when the top of the vehicle is removed or retracted. Furthermore, current storage systems are typically made of plastic or metal so that vehicle occupants cannot see what is stored within, which may cause distraction when trying to remove these items from the storage system. There are some current netting solutions for vehicle storage. It is believed that the netting in these solutions is often very deformable.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a diagrammatic top view of an exemplary storage apparatus, in accordance with an embodiment of the present invention;

FIG. 2 illustrates a diagrammatic top view of exemplary tubes in an exemplary storage apparatus, in accordance with an embodiment of the present invention;

FIG. 3 illustrates a cross sectional view of a portion of an exemplary frame attached to support member with an exemplary attachment strap and an exemplary securing clip, in accordance with an embodiment of the present invention;

FIG. 4 illustrates a cross sectional view of a portion of an exemplary frame attached with an exemplary strap and an exemplary clip, in accordance with an embodiment of the present invention;

FIG. 5 illustrates a diagrammatic side view of an exemplary handle and an exemplary attachment strap, in accordance with an embodiment of the present invention;

FIG. 6 illustrates a diagrammatic top view of an exemplary cargo retention net, in accordance with an embodiment of the present invention; and

FIG. 7 illustrates top perspective view of an exemplary storage apparatus in use on an exemplary vehicle, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

One embodiment of the present invention relates to an overhead storage shelving system inside a vehicle for storing personal cargo. In some embodiments, the storage system comprises netting attached to a tubular frame element, which has a plurality of straps and securing clips with which the frame is secured to a portion of a vehicle, such as, but not limited to, the roll bar frame of a Jeep Wrangler™ or other type of sport utility vehicle.

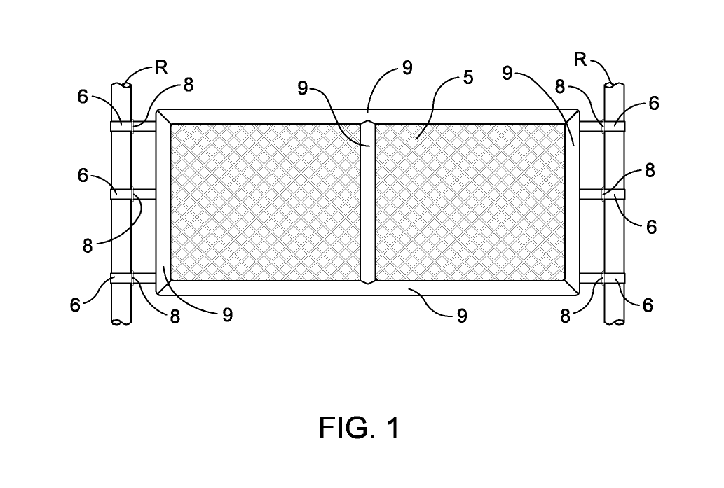

FIG. 1 illustrates a diagrammatic top view of an exemplary storage apparatus, in accordance with an embodiment of the present invention. In the present embodiment, the storage apparatus may join with a support member R of an exemplary vehicle. In some embodiments, the storage apparatus may join with at least one support member R of a vehicle. The support member may include, without limitation, a roll bar, a vehicle roof, a vehicle door, and a rigid frame. In some embodiments, the vehicle may include, without limitation, a Jeep Wrangler™, a sports utility vehicle, a truck, a dune buggy, and a boat. In one embodiment, a plurality of attachment straps 6 may be configured to join the storage apparatus with the at least one support member. A plurality of securing clips 8 may be configured to fasten said plurality of attachment straps 6 with the at least one support member. Attachment straps 6 securely fasten the storage apparatus in an overhead fashion.

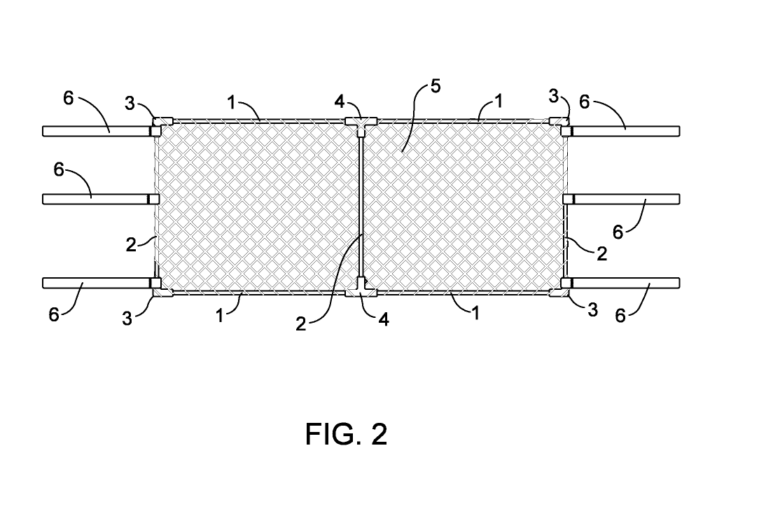

FIG. 2 illustrates a diagrammatic top view of exemplary tubes in an exemplary storage apparatus, in accordance with an embodiment of the present invention. In the present embodiment, the frame may include a rectangular frame formed by at least one tube 1 connected to each other by a T-style compression fitting 4 to create a midpoint. At each end of tube 1 is a 90-degree compression fitting 3. An identical assembly is constructed and mirrored in the same horizontal plane. Completing the rectangular frame, at least one tube 2 is connected to each end of the rectangular frame via 90 degree compression fittings 3 and at the midpoint of the frame via T-style compression fittings 4. Compression fittings 3 and 4 may be interior (inside the tubing) or exterior (outside the tubing) compression fittings made of various different materials including, without limitation, PVC, steel, aluminum, other plastics or metals, etc. In the present embodiment, tubes 1 and 2 are made of plastic coated steel or aluminum. It is contemplated that a multiplicity of suitable materials may be used in some alternate embodiments for the frame members such as, but not limited to, PVC, plastic, acrylic, wood, aluminum, various different metals, composite materials, etc. Furthermore, the frames in some alternate embodiments may be constructed using various different attachment means including, without limitation, screws, bolts, welding, etc.

In the present embodiment, the creation of the storage shelf may be achieved by weaving shelf netting 5 around tubes 1 and 2 and compression fittings 3 and 4 of the rectangular frame. A plurality of attachment straps 6 are attached to tubes 2 and secured. The rigid frame generally maintains shelf netting 5 in a specific shape and also generally keeps netting 5 taut, thus creating an effective shelf that is typically not overly deformed by objects placed on netting 5. Shelf netting 5 may be made of various different materials including, without limitation, woven nylon cargo netting, polyester netting, vinyl netting, spandex netting, metallic mesh, fiberglass screening, transparent plastic sheets, etc. In some alternate embodiments, a multiplicity of elastic bands or cords or inelastic straps may be attached to the frame and woven to create the retention shelf. In one embodiment of the present invention, the frame element provides a rigid frame to which retention barrier 9 may be secured and also provides a secure place to which attachment straps 6 may be attached. In some embodiments, retention barrier 9 is placed over tubes 1 and 2 and compression fittings 3 and 4 to create a barrier to for protecting the rigid frame and to generally prevent cargo from falling from the overhead cargo storage apparatus. Retention barrier 9 is typically made of a foam material. Those skilled in the art will readily recognize, in light of and in accordance with the teachings of the present invention, that a multiplicity of suitable materials may be used for the retention barrier in some alternate embodiments such as, but not limited to plastic, rubber, cloth, silicone, etc. Furthermore, some alternate embodiments may be implemented without a retention barrier.

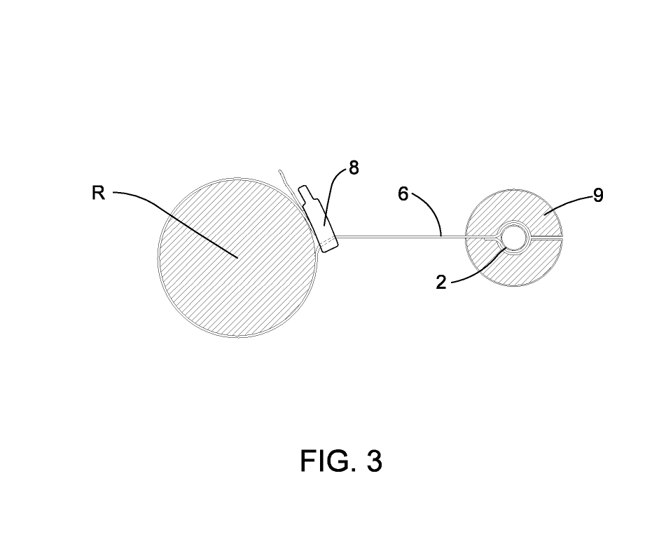

FIG. 3 illustrates a cross sectional view of a portion of an exemplary frame attached to an exemplary support member R with an exemplary strap 6 and an exemplary securing clip 8, in accordance with an embodiment of the present invention. In the present embodiment, attachment straps 6 secure the frame element to support member R. In some embodiments, attachment strap 6 is attached to tube 2 then looped underneath and around support member R. In one embodiment, attachment strap 6 is then looped thru a ladder lock type securing clip 8, tightened and secured.

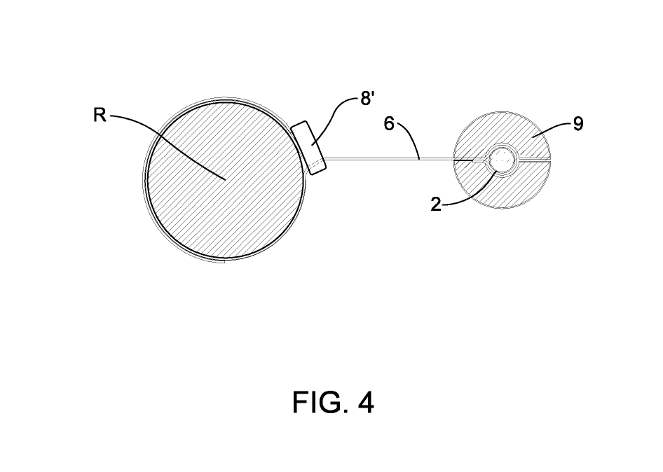

FIG. 4 illustrates a cross sectional view of a portion of an exemplary frame attached with an exemplary strap 6 and an exemplary clip 8, in accordance with an embodiment of the present invention. In the present embodiment, attachment strap 6 may comprise areas of a plurality of hook and loop straps 6. In some embodiments, the plurality of hook and loop straps may loop underneath and around support member R through a plurality of securing clips 8. In one embodiment, the plurality of securing clips may include a plastic slide clip, tightened, then secured by bonding to itself via the areas of the hook and loop material. In some embodiments, the plurality of hook and loop straps may include, without limitation, Velcro, strings, rope, leather straps, buttons, and nonwoven materials. Those skilled in the art will readily recognize, in light of and in accordance with the teachings of the present invention, that a multiplicity of suitable attachment means may be used in some alternate embodiments such as, but not limited to, various different clasps, snaps, hook and loop material alone, buckles, etc. Attachment straps 6 may be made of nylon webbing, strap material, plastic, elastic bands, etc. In the present embodiment, tubes 1 and 2 are hollow cylindrical tubes. Although, the frame members in some alternate embodiments may be of various different shapes such as, but not limited to, solid cylindrical rods, square tubing or rods, etc.

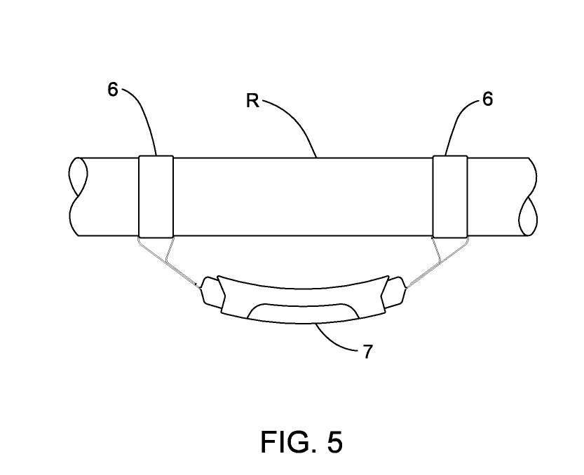

FIG. 5 illustrates a diagrammatic side view of an exemplary handle 7 and an exemplary attachment strap 6, in accordance with an embodiment of the present invention. In the present embodiment, the storage apparatus comprises at least one handle 7 near the attachment points on roll bars R. Handle 7 is an elastomer or elastically deformable plastic molded handle with straps and is attached to support member R via attachment straps 6. In the present embodiment, attachment straps 6 are inserted into loops at each end of handle 7 prior to being secured to support member R. Straps 6 are then looped underneath and around support member R tightened and secured to generally hold handle 7 to support member R. At least one handle 7 may be attached to each side of the vehicle to aid the vehicle occupants in and out of the vehicle and to also provide a comfortable place to rest the hands. It is contemplated that various different types of handles may be used in some alternate embodiments such as, but not limited to, loops of strapping or handles that are permanently attached to the storage apparatus, for example without limitation, to the frame element or to the attachment straps, and some alternate embodiments may be implemented without handles.

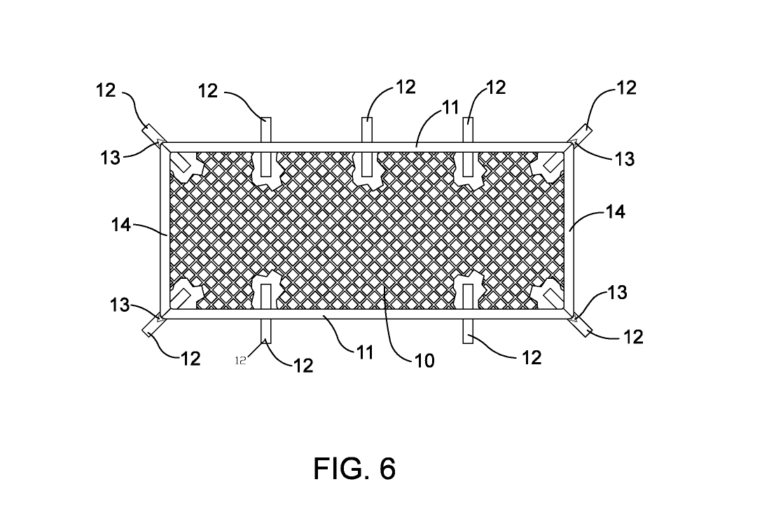

FIG. 6 illustrates a diagrammatic top view of an exemplary cargo retention net 10, in accordance with an embodiment of the present invention. In the present embodiment, the storage apparatus also includes, without limitation, cargo retention net 10, which typically keeps cargo inside the vehicle if the top is retracted or removed. Referring to FIG.6, cargo retention net 10 is made of woven nylon cargo netting that is sewn inside of a rectangular elastic border. The elastic border is made of two long pieces of elastic fabric 11 and two shorter pieces of elastic fabric 14. Sewn to the elastic net assembly is a plurality of hook and loop straps 12. These straps are able to be attached around retention barrier 9 and the frame element. Also attached to the elastic border is a plurality of clips 13. In one embodiment, the plurality of clips 13 may include four plastic triangle clips or tri-rings positioned on the four corners of the elastic border. Those skilled in the art, in light of the present teachings will recognize that, the plurality of clips may join with the retention net so that if the storage apparatus is in a raised position, the retention net may be utilized in various areas of the vehicle. In this manner, the plurality of clips may secure the storage apparatus to numerous areas of the vehicle. The plurality of clips may include, without limitation, four plastic triangle clips, tri-rings, straps, and brackets.

In one alternative embodiment the retention means and border may be fabricated of various different materials including, but not limited to, different types of fabric, plastic mesh, plastic sheets, metal, foam, nylon webbing, etc. Also, in some alternate embodiments, the retention means may be opaque or translucent rather than being a see through netting. It is further contemplated, that attachment means other than hook and loop straps may be used in some alternate embodiments such as, but not limited to, straps with clasps, buckles, snaps, etc., snaps or hook and loop material that connects directly to the retention barrier or frame without straps, clips, hooks, etc. In other alternate embodiments, the retention net may be permanently attached, for example, without limitation, by sewing, to the retention barrier, frame or shelf netting on one or more sides of the apparatus. For example, without limitation, in one such embodiment, the retention net may be sewn along one edge of the apparatus so that it may be rolled out over the shelf when needed and rolled away or retracted when not needed. In another such embodiment, the retention net may be sewn to the apparatus on three sides, leaving one side open for placement and retrieval of items between the shelf netting and the retention net.

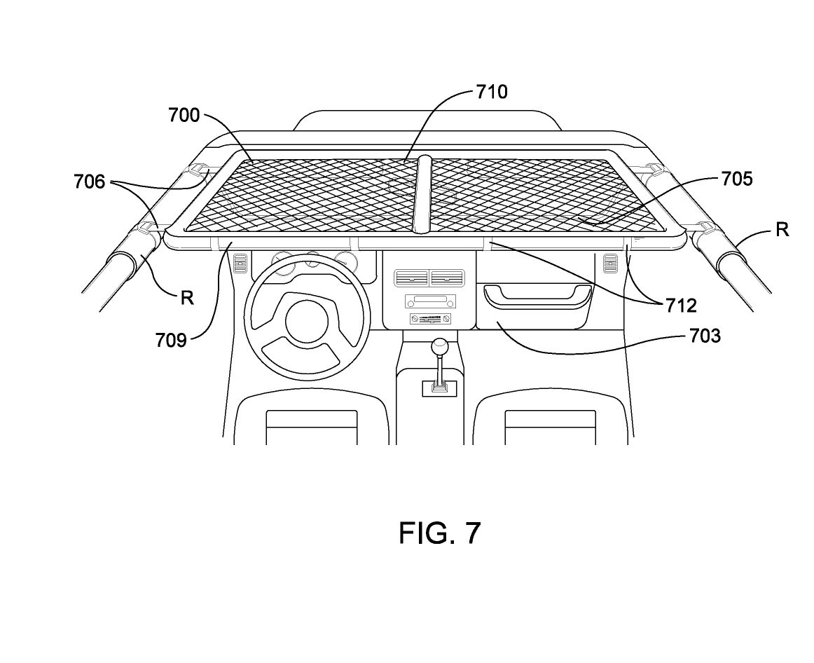

FIG. 7 illustrates top perspective view of an exemplary storage apparatus 700 in use on an exemplary vehicle 703, in accordance with an embodiment of the present invention. In the present embodiment, storage apparatus 700 may effectively store personal items or cargo such as, but not limited to, mobile phones, water bottles, clothing, glasses, wallets, etc. in an overhead fashion in the interior of a vehicle above the driver and passenger. Storage apparatus 700 lies in a substantially horizontal plane and fits in between parallel support members R above the driver and passenger seats. Attachment straps 706 are wrapped around and secured to roll bars R. A rigid frame element covered in a retention barrier 709 generally holds a shelf netting 705 taut to provide a stable storage shelf and to generally prevent items from distorting the shape of netting 705, which typically keeps the apparatus from sagging into the view of the driver and/or passenger. Shelf netting 705 is a woven material comprising many holes which generally enables the vehicle occupants to see what is being stored overhead and typically makes for easy access to the stored items. In the present embodiment, storage apparatus 700 is easily removable and can be used whether the top of the vehicle is in place or not. When the top of the vehicle is in place, retention barrier 709, typically makes contact with the interior roof of the vehicle to generally retain items neatly overhead between shelf netting 705 and the roof of the vehicle. Retention barrier 709 may also generally prevent items from falling vertically from overhead and from shuffling about the cabin and causing a disturbance to the vehicle occupants. Storage apparatus 700 comprises a cargo retention net 710 which can generally prevent items from being blown from or falling from the vehicle when the top is retracted or removed. In order to achieve this, retention net 710 is attached to the frame element with straps 712 over items placed on shelf netting 705. These items are then securely held between shelf netting 705 and retention net 710, even when the vehicle is in motion. Storage apparatus 700 is easily and quickly removable from the vehicle. Furthermore, storage apparatus 700 is typically made of lightweight materials making handling and storage easy and convenient.

In one embodiment of the present invention, storage apparatus 700 may be secured to the parallel support members R of a Jeep Wrangler™ utility vehicle without any alterations to the vehicle. Storage apparatus 700 may also be used in various different types of vehicles with compatible ROLLBAR/roof features. Other embodiments may comprise different or adjustable attachment means in order to be attached to a wider range of vehicles. Yet other embodiments may be made in which the rigid frames have various different shapes, sizes or configurations to be used in various different vehicles, locations within vehicles, or applications. For example, without limitation, circular or irregular shapes may be used for the rigid frame, and various different configurations of frame members and support tubes may be used. Also, the size of the frame may vary depending on the dimensions of the vehicle or location in which the apparatus is to be used. Non-limiting examples of locations within a vehicle where an embodiment of the present invention may be used include, without limitation, near the roof above the rear seats, in a trunk, behind the front seats, across the rear seat, above the headrests of the front or rear seats, etc. In some embodiments, a storage apparatus may be permanently attached to a vehicle.

It is contemplated that some embodiments may be implemented to be used in various different types of applications other than in automobiles. For example, without limitation, a storage apparatus according to an embodiment of the present invention may be used to create a shelf in a boat by being attached to a boat tower or another location. Some embodiments may be used in yet other types of vehicles such as, but not limited to, all-terrain vehicles, delivery trucks, tractors, recreational vehicles, golf carts, dune buggies, small aircraft, etc. Some embodiments may also be used outside of vehicles. For example, without limitation, a storage apparatus may be attached to tree branches when camping and used as a shelf for storing personal camping items or food. Those skilled in the art will readily recognize, in light of and in accordance with the teachings of the present invention, that by using a variety of different attachment means, some embodiments may be implemented to be used as a shelf for practically anything in a multiplicity of suitable applications, such as, but not limited to, in a tent, in a closet, as a drying rack in a laundry room, etc.

Some embodiments may be implemented with a semi-rigid frame element or without a frame element. In these embodiments, the netting may be encased in elastic to be stretchable or a fabric or plastic edging. In some variations the edging may be reinforced with stiffer materials such as, but not limited to, metal wire, nylon webbing, plastic strips, fabric interfacing, etc. to provide some rigidity. The edging comprises a plurality of grommet holes or other attachment means such along the sides where attachment straps are placed to attach the apparatus to a vehicle. Various different types of attachment straps may be used such as, but not limited to, hook and loop attachment straps with or without grommet holes, straps with various different clasps, elastic bands, etc. The netting configuration may be permanently attached to the attachment straps or, with attachment straps with grommet holes, the netting may be attached with a carbineer type clip or other type of clip thru each of the grommet holes of the edging and the attachment straps.

In some embodiments the storage apparatus may be broken down into smaller elements to be provided separately. For example, without limitation, the frame element and net could be sold as a shelf. Then attachment straps, retention barriers and retention nets may be provided separately to be attached to the frame element and net.

Those skilled in the art will readily recognize, in light of and in accordance with the teachings of the present invention, that a multiplicity of suitable additional or alternate features may be available in some embodiments such as, but not limited to, pockets with or without closures including, without limitation, hook and loop material, zippers, snaps, buttons, drawstrings, etc., overhead lights, waterproof pouches, a retractable cover over the top of the cargo storage apparatus, etc.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of providing a storage apparatus according to the present invention will be apparent to those skilled in the art. The invention has been described above by way of illustration, and the specific embodiments disclosed are not intended to limit the invention to the particular forms disclosed. For example, the particular implementation of the mounting means may vary depending upon the particular type of location in which the apparatus is to be used. The mounting means described in the foregoing were directed to attachment strap implementations; however, similar techniques are to provide storage apparatuses with various different mounting means such as, but not limited to, spring-loaded tension rods, hooks, brackets, etc. Implementations of the present invention comprising different mounting means are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A storage apparatus comprising:
at least one tube, said at least one tube being configured to provide a frame for said storage apparatus, said at least one tube being disposed to join with at least one support member;
a shelf netting, said shelf netting being disposed to position between said at least one tube, said shelf netting being configured to support at least one object;
at least one retention barrier, said retention barrier being configured to enclose said at least one tube; and
a retention net, said retention net being configured to overlay said at least one object and said shelf netting, said retention net being disposed to position between said at least one retention barrier.

2. The storage apparatus of claim 1, in which said at least one support member comprises a roll bar.

3. The storage apparatus of claim 2, in which said at least one tube comprises a rectangular shape, said at least one tube further comprising a plastic coated corrosion resistant, steel tube.

4. The storage apparatus of claim 3, in which said at least one tube comprises at least one fitting, said at least one fitting being configured to join said at least one tube together.

5. The storage apparatus of claim 4, in which said at least one fitting comprises a ninety degree compression fitting.

6. The storage apparatus of claim 5, in which said shelf netting comprises a nylon polymer woven net.

7. The storage apparatus of claim 6, in which said storage apparatus comprises a plurality of attachment straps, said plurality of attachment straps being configured to secure said at least one tube with said at least one support member.

8. The storage apparatus of claim 7, in which said plurality of attachment straps comprise a plurality of securing clips, said plurality of securing clips being configured to fasten said plurality of attachment straps to said at least one support member.

9. The storage apparatus of claim 8, wherein said plurality of securing clips comprise a ladder lock type, said plurality of securing clips further comprising a rigid plastic, said plurality of securing clips being operable to self-adjust.

10. The storage apparatus of claim 9, in which said at least one retention barrier comprises a protective foam, said protective foam being configured to protect said at least one tube.

11. The storage apparatus of claim 10, in which said retention net comprises a border, said border comprising a rectangular shape, said border further comprising at least one long fabric, said border further comprising at least one short fabric.

12. The storage apparatus of claim 11, in which said at least one long fabric comprises nylon.

13. The storage apparatus of claim 12, in which said at least one short fabric comprises nylon.

14. The storage apparatus of claim 13, in which retention net comprises a plurality of hook and loop straps, said plurality of hook and loop straps being configured to join said retention net with said retention barrier, said plurality of hook and loop straps comprising Velcro.

15. The storage apparatus of claim 14, in which retention net comprises a plurality of clips, said plurality of clips being configured to join said retention net with said at least one support member, said plurality of clips further being configured to join said retention net with an area of a vehicle.

16. The storage apparatus of claim 15, in which said retention net comprises a nylon polymer woven netting.

17. The storage apparatus of claim 16, in which said storage apparatus comprises at least one handle, said at least one handle being configured to be operable to be gripped for support.

18. The storage apparatus of claim 17, wherein said at least one handle is disposed to join with said support member.

19. A method for storing comprising:
means for removing a top from a vehicle;
means for orienting a storage apparatus on a vehicle;
means for securing a shelf netting to a support member;
means for positioning at least one object on said shelf netting;
means for overlaying a retention net on said at least one object;
means for securing said retention net to a support member with a plurality of attachment straps; and
means for storing said at least one object.

20. A storage apparatus consisting of:
at least one tube, said at least one tube being configured to provide a frame for said storage apparatus, said at least one tube being disposed to join with at least one support member;
a shelf netting, said shelf netting being disposed to position between said at least one tube, said shelf netting being configured to support at least one object, said shelf netting comprising a nylon polymer woven net;
at least one retention barrier, said retention barrier being configured to enclose said at least one tube;
a plurality of attachment straps, said plurality of attachment straps being configured to secure said at least one tube with said at least one support member, said plurality of attachment straps further comprising a plurality of securing clips, said plurality of securing clips being configured to fasten said plurality of attachment straps to said at least one support member;
a retention net, said retention net being configured to overlay said at least one object and said shelf netting, said retention net being disposed to position between said at least one retention barrier, said retention net comprising a plurality of hook and loop straps, said plurality of hook and loop straps being configured to join said retention net with said retention barrier, said plurality of hook and loop straps comprising Velcro, said retention net further comprising a plurality of clips, said plurality of clips being configured to join said retention net with said at least one support member, said plurality of clips further being configured to join said retention net with an area of a vehicle, said retention net further comprising a border, said border comprising a rectangular shape, said border further comprising at least one long fabric, said border further comprising at least one short fabric, said retention net further comprising a nylon polymer woven net; and
at least one handle, said at least one handle being configured to be operable to be gripped for support, said at least one handle being disposed to join with said support member.
